(19) United States
(12) Patent Application Publication
(10) Pub. No.: US 2014/0345305 A1
(43) Pub. Date: Nov. 27, 2014

(54) AIRCRAFT COOLING SYSTEM AND METHOD FOR OPERATING AN AIRCRAFT COOLING SYSTEM

(71) Applicant: Airbus Operations GmbH, Hamburg (DE)

(72) Inventors: Martin Sieme, Hamburg (DE); Markus Piesker, Hamburg (DE); Charles Soberano, Toronto (CA)

(21) Appl. No.: 14/282,736

(22) Filed: May 20, 2014

(30) Foreign Application Priority Data
May 21, 2013 (DE) 102013008620.5

(51) Int. Cl. B64D 13/08

(52) U.S. Cl. CPC B64D 13/08; B64D 2013/0618
USPC 62/79; 62/241; 62/238.6; 165/96

(57) ABSTRACT

An aircraft cooling system comprising a refrigerating device and a heat exchanger thermally coupled to the refrigerating device. A ram air duct of the aircraft cooling system is adapted to supply cooling air to the heat exchanger, in order to remove waste heat generated in the operation of the refrigerating device from the heat exchanger to the aircraft surroundings. A connecting element comprises a first end connected to the ram air duct and a second end connectable to a device for providing conditioned air and is adapted to supply conditioned air to the ram air duct, at least in certain operating phases of the aircraft cooling system.

### CROSS-REFERENCES TO RELATED APPLICATIONS

This application claims the benefit of the German patent application No. 10 2013 008 620.5 filed on May 21, 2013, the entire disclosures of which are incorporated herein by way of reference.

### BACKGROUND OF THE INVENTION

The invention relates to a cooling system suitable in particular for cooling food, but also heat-generating devices, such as for example electronic components, on board an aircraft. Furthermore, the invention relates to a method for operating such a cooling system.

Aircraft cooling systems which are suitable for cooling food, but also heat-generating devices, such as for example electronic components, on board an aircraft, are known for example from DE 43 403 17 C2 or U.S. Pat. No. 5,513,500, from DE 10 2006 005 035 B3 or WO 2007/088012 A1, or from DE 10 2009 011 797 A1 or US 2010/251737 A1. These aircraft cooling systems are equipped with a central refrigerating device which supplies cooling energy to a liquid or two-phase refrigerating medium circulating in a refrigerating medium circuit. The cooling energy generated by the refrigerating device is led via the refrigerating medium to the cooling energy consumers present on board the aircraft.

Waste heat generated by the refrigerating device is normally removed to the aircraft surroundings by means of a heat exchanger which is arranged in a ram air duct described, for example, in DE 10 2009 017 040 A1 or U.S. Pat. No. 8,262,018 B2. When the aircraft is in flight, ram air flows through the ram air duct. By contrast, when the aircraft is on the ground, a fan provided in the ram air duct ensures that sufficient ambient air for cooling the heat exchanger is conveyed through the ram air duct. Both the refrigerating device and the heat exchanger for removing the waste heat generated by the refrigerating device in operation are normally designed and dimensioned such that the devices on board the aircraft which are to be cooled can be supplied with sufficient cooling energy also under extreme conditions, such as e.g., when the aircraft is on the ground at very high outside temperatures.

### SUMMARY OF THE INVENTION

An object on which the invention is based is to provide an aircraft cooling system which is optimized with regard to its weight and its installation space requirement. Furthermore, an object on which the invention is based is to specify a method for operating such an aircraft cooling system.

An aircraft cooling system comprises a refrigerating device which is adapted to generate cooling energy in operation. The refrigerating device may be configured, for example, in the form of a compression refrigerating machine and be adapted to release the cooling energy generated by it to a refrigerating medium circulating in a refrigerating medium circuit. The refrigerating medium circulating in the refrigerating medium circuit may be a liquid refrigerating medium or a two-phase refrigerating medium. The cooling energy generated by the refrigerating device may be supplied via the refrigerating medium circuit to various consumers on board an aircraft. Cooling energy consumers which are supplied with cooling energy with the aid of the aircraft cooling system may be, for example, food stored on board the aircraft in the region of the galleys, but also heat-generating devices, such as e.g., electronic components, or also spaces to be cooled.

The aircraft cooling system further comprises a heat exchanger thermally coupled to the refrigerating device. The heat exchanger may be embodied, for example, in the form of a condenser and serve to remove the waste heat generated by the refrigerating device in operation from the refrigerating device. If the aircraft cooling system comprises a plurality of refrigerating devices, each refrigerating device may be assigned a separate heat exchanger for the waste heat removal. Alternatively to this, however, it is also conceivable to remove the waste heat of a plurality of refrigerating devices from the refrigerating devices via merely one correspondingly dimensioned heat exchanger.

A ram air duct of the aircraft cooling system is adapted to supply cooling air to the heat exchanger thermally coupled to the refrigerating device, in order to remove waste heat generated in the operation of the refrigerating device from the heat exchanger to the aircraft surroundings. Preferably, the heat exchanger is arranged in the ram air duct, so that ambient air flowing through the ram air duct can be led directly through the heat exchanger and a particularly efficient heat transfer to the ambient air flowing through the ram air duct can be thereby realized. In the ram air duct there may further be arranged a conveying device, configured for example in the form of a fan, for conveying ambient air through the ram air duct. For example, the conveying device may be positioned in the ram air duct downstream of the heat exchanger. The term “downstream” here refers to the flow direction of the ambient air through the ram air duct.

When the aircraft is in flight, ram air flows through the ram air duct, the ram air flow through the ram air duct being able to be controlled by a corresponding control of a ram air duct inlet flap provided in the region of a ram air duct inlet and/or of a ram air duct outlet flap or an outlet nozzle provided in the region of a ram air duct outlet. By opening the ram air duct inlet flap and/or the ram air duct outlet flap, the ambient air volume flow through the ram air duct and thus the amount of cooling energy available for cooling the heat exchanger can be increased. The opening of the ram air duct inlet flap and/or the ram air duct outlet flap, however, increases the aerodynamic loss caused by the ram air duct and consequently the fuel consumption of the aircraft. When the aircraft is on the ground, the conveying device arranged in the ram air duct can ensure that sufficient ambient air flows through the ram air duct to ensure a proper heat removal from the heat exchanger thermally coupled to the refrigerating device.

The aircraft cooling system is equipped with a connecting element which comprises a first end connected to the ram air duct and a second end connectable to a device for providing conditioned air. The connecting element is adapted to supply conditioned, i.e., treated cooled, air to the ram air duct, at least in certain operating phases of the aircraft cooling system. As will be explained in more detail below, the conditioned air to be supplied to the ram air duct can be provided by various aircraft-internal and/or aircraft-external devices. All that is essential is that, if required, conditioned air can be led into the ram air duct and used to cool the heat exchanger thermally coupled to the refrigerating device. In principle, it is conceivable to supply conditioned air to the ram air duct in all operating phases of the aircraft cooling system. Preferably, however, the supply of conditioned air into the ram air duct is limited to certain operating phases of the aircraft cooling system. For example, conditioned air can be supplied to the ram air duct when an aircraft equipped with the aircraft cooling system is on the ground, in particular at high outside temperatures, or when the aircraft is in flight or on the ground, if the refrigerating device is operated under high load.

As a result, it is no longer necessary for the ram air duct, the heat exchanger and a conveying device, which is arranged in the ram air duct and conveys the ambient air through the ram air duct when an aircraft equipped with the aircraft cooling system is on the ground, to be designed such that a sufficient heat removal from the refrigerating device is ensured solely by the ambient air flowing through the ram air duct also under extreme conditions, for example at very hot outside temperatures and/or on operation of the refrigerating machine under full load. Consequently, the ram air duct, the heat exchanger and the conveying device can be designed lighter in weight and smaller in volume. Optionally, the conveying device can even be completely dispensed with.

A reduction of the maximum temperature of the cooling air used for cooling the heat exchanger thermally coupled to the refrigerating device can further result in an increase of the efficiency of the refrigerating device. Consequently, the refrigerating device can also be designed smaller and lighter. Moreover, the range between required maximum output and minimum output of the refrigerating device decreases, whereby the operating efficiency and the robustness of the refrigerating device can be improved. Finally, the configuration of the aircraft cooling system with a connecting element, via which conditioned air can be supplied to the ram air duct, at least in certain operating phases of the aircraft cooling system, enables the operation of the refrigerating device with a greater range of refrigerating media, since now it is also possible to use refrigerating media which are not usable or are only usable to a limited extent at higher cooling air temperatures. Such a refrigerating medium is, for example, CO2 (R744).

The connecting element may have a first end which may be connected to a ram air duct inlet, formed in an aircraft outer skin, of the ram air duct. In such a configuration of the connecting element, conditioned air can be supplied to the ram air duct via the ram air duct inlet. The formation of additional openings in the ram air duct for supplying conditioned air into the ram air duct can then be dispensed with. Rather, the ram air duct inlet can then be connected to the device for providing conditioned air in a simple and convenient manner via the connecting element. Such a configuration of the aircraft cooling system is expedient in particular when conditioned air is to be supplied to the ram air duct only when an aircraft equipped with the aircraft cooling system is on the ground.

Alternatively to this, however, the first end of the connecting element may also be connected to a region of the ram air duct located downstream of the ram air duct inlet. The term “downstream” in this context refers to the flow direction of the air, i.e., of the ambient air and/or the conditioned air, through the ram air duct. In such a configuration, the ram air duct has to be provided with an additional opening for connecting the ram air duct to the connecting element. Conditioned air may, however, also be supplied to the ram air duct when an aircraft equipped with the aircraft cooling system is in flight, via a connecting element whose first end is connected to a region of the ram air duct located downstream of the ram air duct inlet. Furthermore, it is possible to supply to the ram air duct simultaneously ambient air through the ram air duct inlet and conditioned air via the additional opening connected to the connecting element.

Finally, it is also conceivable to equip the aircraft cooling system with a plurality of connecting elements, in which case a first end of at least one connecting element may be connected to a ram air duct inlet formed in an aircraft outer skin and a first end of at least one further connecting element may be connected to a region of the ram air duct located downstream of the ram air duct inlet. The connecting elements may connect the ram air duct to only one device for providing conditioned air. However, it is also conceivable to connect the ram air duct via a plurality of connecting elements to a plurality of devices for providing conditioned air.

The connecting element may be configured in the form of a hose or a pipe. In particular when the connecting element is provided to be connected at its first end to a ram air duct inlet, formed in an aircraft outer skin, of the ram air duct, the connecting element may also be designed and dimensioned such that it adheres to the ram air duct inlet owing to the negative pressure arising in the region of the ram air duct inlet when the conditioned air is supplied into the ram air duct. Such a design of the connecting element makes it possible to dispense with the fitting of an aircraft, equipped with the aircraft cooling system, with a fastening device for fastening the connecting element to the aircraft.

A second end of the connecting element may be adapted to be connected to an aircraft-external air conditioning unit, an aircraft-internal air conditioning unit of an aircraft air conditioning system, a supply line of the aircraft air conditioning system which is adapted to supply conditioned air to the aircraft cabin, and/or a cabin exhaust air line for removing exhaust air from the aircraft cabin. In other words, the device for providing conditioned air may comprise an aircraft-external air conditioning unit, an aircraft-internal air conditioning unit of an aircraft air conditioning system, a supply line of the aircraft air conditioning system which is adapted to supply conditioned air to the aircraft cabin, and/or a cabin exhaust air line for removing exhaust air from the aircraft cabin, or can be formed by these components.

An aircraft-external air conditioning unit which is suitable for use as a device for providing conditioned air in an aircraft cooling system is described, for example, in EP 2 307 274 B1 or US 2011/0177771 A1 or EP 2 401 201 B1 or US 2012/0064816 A1. It is understood that a device for providing conditioned air comprising an aircraft-external air conditioning unit may be used to lead conditioned air into the ram air duct only when an aircraft equipped with the aircraft cooling system is on the ground. If desired, an aircraft-external air conditioning unit used in the aircraft cooling system as a device for providing conditioned air may also be used to supply conditioned air to the cabin of the aircraft. As a result, not only the aircraft cooling system, but also the air conditioning system of the aircraft can be relieved when the aircraft is on the ground.

When conditioned air generated directly by an aircraft-internal air conditioning unit of an aircraft air conditioning system or branched off from a conditioned air-guiding supply line of the aircraft air conditioning system is supplied to the ram air duct, the heat exchanger thermally coupled to the refrigerating device can be cooled by conditioned air not only when the aircraft is in on the ground, but also when it is in flight. This may be advantageous particularly in operating phases in which the aircraft air conditioning system is not fully utilized, since the ram air flow through the ram air duct can then be reduced or even stopped. Consequently, the aerodynamic losses caused by the ram air duct can be reduced and the fuel consumption of the aircraft can be reduced.

When exhaust air from the aircraft cabin is utilized to cool the heat exchanger thermally coupled to the refrigerating device, the heat exchanger can likewise be supplied with cooling air of a corresponding temperature not only when the aircraft is on the ground, but also when it is in flight. The cabin exhaust air temperature is normally 20 to 24° C., at most 30° C. Thus, although the exhaust air removed from the aircraft cabin is generally warmer than air generated by an aircraft-internal air conditioning unit of an aircraft air conditioning system, the aircraft air conditioning system is not additionally loaded when using cabin exhaust air for cooling the heat exchanger thermally coupled to the refrigerating device. Rather, air which would otherwise be removed unused into the aircraft surroundings is used in a particularly energy-efficient manner for cooling the heat exchanger thermally coupled to the refrigerating device.

The cabin exhaust air can be withdrawn from any desired pressurized region of the aircraft, thus for example a passenger cabin, a cargo compartment or a bilge. Similarly to the use of conditioned air which is withdrawn from an aircraft-internal air conditioning unit of an aircraft air conditioning system or from a conditioned air-guiding supply line of the aircraft air conditioning system, the use of cabin exhaust air for cooling the heat exchanger thermally coupled to the refrigerating device also enables a reduction of the ram air flow through the ram air duct when the aircraft is in flight. This in turn enables a reduction of the aerodynamic losses of the aircraft produced by the ram air duct, as well as a reduction of the fuel consumption of the aircraft resulting therefrom.

In particular when the heat exchanger of the aircraft cooling system thermally coupled to the refrigerating device is to be cooled by exhaust air removed from the aircraft cabin, the second end of the connecting element may be connected to a cabin exhaust air outlet formed in an aircraft outer skin. Such a configuration is suitable in particular when the aircraft is on the ground, since then no additional aircraft-internal lines are required in order to lead the exhaust air, removed from the aircraft cabin, into the ram air duct. Rather, it is merely necessary to connect a connecting element, configured for example in the form of a hose or the like, at its first end to the ram air duct inlet of the ram air duct and at its second end to the cabin exhaust air outlet formed in the aircraft outer skin.

Alternatively to this, however, the second end of the connecting element may also be connected to a region of the cabin exhaust air line located upstream of the cabin exhaust air outlet. The term “upstream” here refers to the flow direction of the cabin exhaust air through the cabin exhaust air line. Such a configuration of the connecting element makes it possible to lead exhaust air, removed from the aircraft cabin, into the ram air duct also when the aircraft is in flight.

Finally, it is conceivable, in an aircraft cooling system comprising a plurality of connecting elements, to connect a second end of at least one connecting element to a cabin exhaust air outlet formed in an aircraft outer skin and to connect a second end of at least one further connecting element to a region of the cabin exhaust air line located upstream of the cabin exhaust air outlet. At least one connecting element can then serve to supply cabin exhaust air to the ram air duct when the aircraft is in flight, whereas when the aircraft is on the ground alternatively or additionally at least one further connecting element can be used to supply exhaust air, removed from the aircraft cabin via the cabin exhaust air outlet, to the ram air duct.

The aircraft cooling system may further comprise a device for pneumatic uncoupling which is adapted to pneumatically uncouple a volume flow of conditioned air supplied to the connecting element from a volume flow of conditioned air coming out of the connecting element. This is expedient in particular when the conditioned air is supplied to the connecting element with a pressure and/or a volume flow which differs from the pressure and/or the volume flow with which the conditioned air is to be led into the ram air duct. For example, a device for pneumatic uncoupling can be used to uncouple a cabin exhaust air flow which is withdrawn from a cabin exhaust air outlet formed in an aircraft outer skin from an air flow supplied to the ram air duct via a ram air duct inlet.

The aircraft cooling system may further comprise a control unit which is adapted to control the operation of a valve of the connecting element, a ram air duct inlet flap and/or a ram air duct outlet flap in such a manner that a volume flow of the conditioned air supplied to the ram air duct, at least in certain operating phases of the aircraft cooling system, corresponds to a desired volume flow. The valve of the connecting element may be configured, for example, in the form of a flap and be arranged in the region of the first end of the connecting element, in the region of the second end of the connecting element or at another place in the connecting element. By means of the valve, the supply of conditioned air into the ram air duct can be controlled as desired. Alternatively or additional to this, a corresponding control of the ram air duct inlet flap and/or the ram air duct outlet flap by the control of the pressure conditions in the ram air duct resulting therefrom enables a control of the volume flow of conditioned air through the ram air duct. The control unit may, however, also be adapted, by a corresponding control of the ram air duct inlet flap and/or the ram air duct outlet flap, to admix a desired volume flow of ambient air with the volume flow of conditioned air led through the ram air duct, so that a mixed air volume flow containing conditioned air and ambient air flows through the ram air duct.

The control unit may further be adapted to determine the desired volume flow of the conditioned air supplied to the ram air duct, at least in certain operating phases of the aircraft cooling system, in dependence on the ambient temperature, the cooling output requirement demanded of the aircraft cooling system and/or the current capacity of the device for providing conditioned air. For this purpose, signals may be transmitted to the control unit, for example by corresponding sensors, which signals deliver to the control unit information relating to the ambient conditions, in particular the ambient temperature, the operating state of the aircraft cooling system, in particular the cooling output requirement demanded of the aircraft cooling system and/or the capacity of the device for providing conditioned air.

In a method for operating an aircraft cooling system, cooling energy is generated by means of a refrigerating device. Cooling air is supplied to a heat exchanger, thermally coupled to the refrigerating device, by means of a ram air duct, in order to remove waste heat generated in the operation of the refrigerating device from the heat exchanger to the aircraft surroundings. Conditioned air provided by a device for providing conditioned air is supplied to the ram air duct, at least in certain operating phases of the aircraft cooling system.

In a preferred embodiment of the method for operating an aircraft cooling system, conditioned air provided by the device for providing conditioned air is supplied to a ram air duct inlet formed in an aircraft outer skin. Alternatively or additionally to this, conditioned air provided by the device for providing conditioned air may also be supplied to a region of the ram air duct located downstream of the ram air duct inlet.

The ram air duct may be supplied with conditioned air by an aircraft-external air conditioning unit, an aircraft-internal air conditioning unit of an aircraft air conditioning system, a supply line of the aircraft air conditioning system which is adapted to supply conditioned air to the aircraft cabin, and/or a cabin exhaust air line for removing exhaust air from the aircraft cabin.

Conditioned air may be supplied to the ram air duct from a cabin exhaust air outlet formed in an aircraft outer skin. Additionally or alternatively to this, conditioned air may be supplied to the ram air duct from a region of the cabin exhaust air line located upstream of the cabin exhaust air outlet.

A volume flow of conditioned air coming out of the device for providing conditioned air may be pneumatically uncoupled from a volume flow of conditioned air supplied to the ram air duct.

The operation of a valve of a connecting element which comprises a first end connected to the ram air duct and a second end connectable to the device for providing conditioned air may be controlled by means of a control unit in such a manner that a volume flow of the conditioned air supplied to the ram air duct, at least in certain operating phases of the aircraft cooling system, corresponds to a desired volume flow. Additionally or alternatively to this, the operation of a ram air duct inlet flap and/or the operation of a ram air duct outlet flap may be controlled by means of a control unit in such a manner that a volume flow of the conditioned air supplied to the ram air duct, at least in certain operating phases of the aircraft cooling system, corresponds to a desired volume flow.

The control unit may determine the desired volume flow of the conditioned air supplied to the ram air duct, at least in certain operating phases of the aircraft cooling system, in dependence on the ambient conditions, in particular the ambient temperature, in dependence on the operating state of the aircraft cooling system, in particular in dependence on the cooling output requirement demanded of the aircraft cooling system, and/or in dependence on the current capacity of the device for providing conditioned air.

### BRIEF DESCRIPTION OF THE DRAWINGS

Preferred embodiments of the invention are now explained in more detail with the aid of the appended schematic drawings, of which

FIG. 1 shows a first embodiment of an aircraft cooling system,

FIG. 2 shows a second embodiment of an aircraft cooling system,

FIG. 3 shows a third embodiment of an aircraft cooling system, and

FIG. 4 shows a fourth embodiment of an aircraft cooling system.

### DETAILED DESCRIPTION OF THE PREFERRED EMBODIMENTS

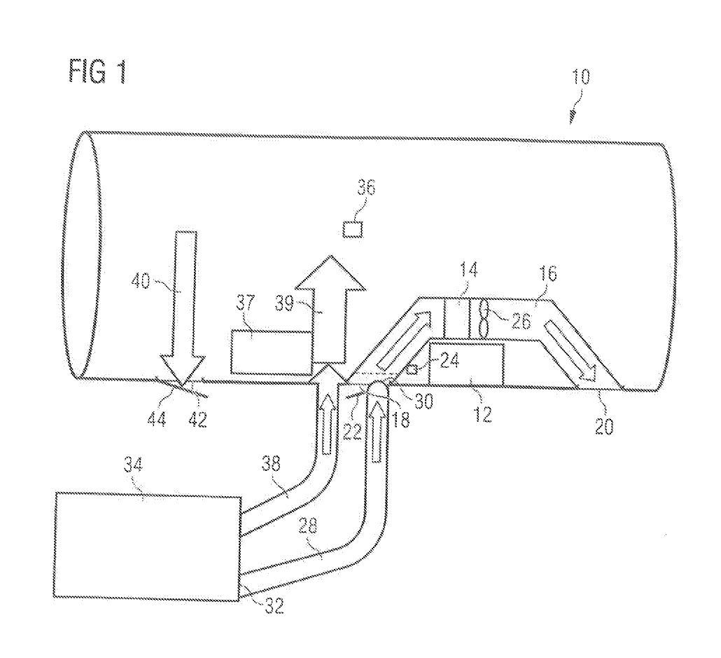

FIG. 1 shows an aircraft cooling system 10 which comprises a refrigerating device 12 configured in the form of a compression refrigerating machine. Cooling energy generated by the refrigerating device 12 is supplied to various cooling energy consumers on board the aircraft via a refrigerating medium which circulates in a refrigerating medium circuit (not illustrated). Waste heat generated by the refrigerating device 12 in operation is removed from the refrigerating device 12 by means of a heat exchanger 14.

The heat exchanger 14 configured in the form of a condenser is arranged in a ram air duct 16. The ram air duct 16 comprises a ram air duct inlet 18 and a ram air duct outlet 20. The ram air duct inlet 18 can be closed by means of a ram air duct inlet flap 22. The ram air duct inlet flap 22 is actuated by an actuator 24. In the embodiment of an aircraft cooling system 10 shown in FIG. 1, the ram air duct 16 is not equipped with a ram air duct outlet flap. If desired, however, it is possible to provide a flap actuable by means of an actuator also in the region of the ram air duct outlet 20.

When the aircraft is in flight, ambient air flows through the ram air duct 16 owing to the ram pressure which builds up in the region of the ram air duct inlet 18 when the aircraft is in flight. When the aircraft is on the ground, by contrast, a conveying device 26 configured in the form of a fan serves to convey ambient air through the ram air duct 16.

The aircraft cooling system 10 further comprises a connecting element 28. In the embodiment of an aircraft cooling system 10 shown in FIG. 1, the connecting element 28 is configured in the form of a hose and has a first end 30 connected to the ram air duct inlet 18 of the ram air duct 16. A second end 32 of the connecting element 28, by contrast, is connected to a device for providing conditioned air, which is formed by an aircraft-external air conditioning unit 34 in the variant of an aircraft cooling system 10 shown in FIG. 1.

Conditioned, i.e., cooled, air generated by the aircraft-external air conditioning unit 34 can be supplied to the ram air duct 16 via the connecting element 28. The supply of conditioned air into the ram air duct 16 can be controlled by means of the ram air duct inlet flap 22, the operation of the ram air duct inlet flap 22 or the operation of the actuator 24 for actuating the ram air duct inlet flap 22 being controlled by an electronic control unit 36. In particular, the control unit 36 controls the operation of the ram air duct inlet flap 22 or the operation of the actuator 24 in such a manner that a volume flow of the conditioned air supplied to the ram air duct 16 by the aircraft-external air conditioning unit 34 corresponds to a desired volume flow. The desired volume flow is determined by the control unit 36 on the basis of signals which are supplied to the control unit 36 by corresponding sensors and which are characteristic of the ambient temperature outside the aircraft, the cooling output requirement demanded of the aircraft cooling system 10 and the current capacity of the aircraft-external air conditioning unit 34.

Furthermore, the control unit 36 controls the operation of the conveying device 26 arranged in the ram air duct 16 in dependence on the volume flow of conditioned air supplied to the ram air duct 16 via the connecting element 28. For example, the control unit 36 can switch off the conveying device 26 when the ram air duct 16 is connected to the aircraft-external air conditioning unit 34 via the connecting element 28, since it is then not necessary to convey ambient air through the ram air duct 16 to cool the heat exchanger 14. Alternatively to this, the operation of the conveying device 26 can, however, also be controlled by the control unit 36 such that the conveying device 26 is used to convey conditioned air generated by the aircraft-external air conditioning unit 34 through the ram air duct 16.

Besides the ram air duct 16, the aircraft-external air conditioning unit 34 also supplies an aircraft cabin directly with conditioned air. As a result, when an aircraft equipped with the aircraft cooling system 10 is on the ground, not only a sufficient cooling of the heat exchanger 14 thermally coupled to the refrigerating device 12 can be ensured, but also an aircraft-internal air conditioning unit 37 of an aircraft air conditioning system can be relieved. For this purpose, the aircraft-external air conditioning unit 34 is connected via a connecting hose 38 to a supply line 39 of the aircraft air conditioning system, which supply line is also connected to the internal air conditioning unit 37 and serves to supply conditioned air generated by the internal air conditioning unit 37 or the aircraft-external air conditioning unit 34 to the aircraft cabin.

Cabin exhaust air to be removed from the aircraft cabin is removed from the aircraft into the aircraft surroundings via a cabin exhaust air line 40 which comprises a cabin exhaust air outlet 42 formed in an aircraft outer skin. The cabin exhaust air flow which is removed into the aircraft surroundings via the cabin exhaust air outlet 42 can be controlled by a cabin exhaust air outlet valve 44 configured in the form of a flap.

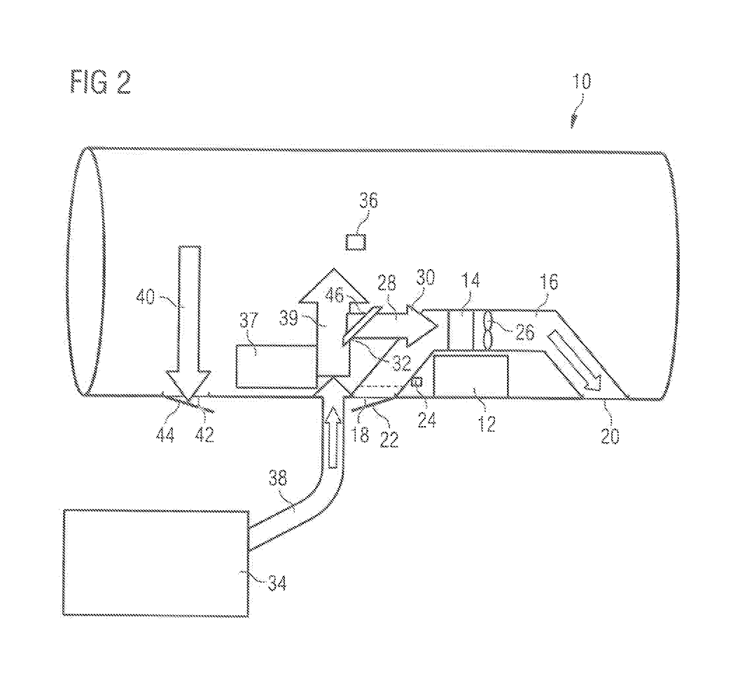

An aircraft cooling system 10 shown in FIG. 2 differs from the arrangement according to FIG. 1 in that conditioned air is supplied to the ram air duct 16, if required, i.e., at least in certain operating phases of the aircraft cooling system 10, by a connecting element 28 whose first end is connected to a region of the ram air duct 16 located downstream of the ram air duct inlet 18. The second end of the connecting element 28 is connected to the supply line 39 of the aircraft air conditioning system which is adapted to supply conditioned air to the aircraft cabin.

When an aircraft equipped with the aircraft cooling system 10 is on the ground, conditioned air generated by the aircraft-external air conditioning unit 34 and/or the aircraft-internal air conditioning unit 37 can be led into the supply line 39 of the aircraft air conditioning system. When the aircraft is in flight, by contrast, conditioned air generated exclusively by the aircraft-internal air conditioning unit 37 is supplied to the supply line 39. In the arrangement according to FIG. 2, the device for providing conditioned air is consequently formed by the supply line 39 of the aircraft air conditioning system.

A valve 46 configured in the form of a flap and provided in the connecting element 28 serves to control the volume flow of conditioned air which is branched off from the supply line 39 of the aircraft air conditioning system and led into the ram air duct 16 via the connecting element 28. The operation of the valve 46 is controlled by the control unit 36 in such a manner that the volume flow of conditioned air flowing through the connecting element 28 corresponds to a desired volume flow.

Furthermore, the control unit 36 also controls the operation of the ram air duct inlet flap 22, i.e., the operation of the actuator 24 actuating the ram air duct inlet flap 22 and the operation of the conveying device 26 arranged in the ram air duct 16. In particular, the control unit 36 controls the operation of these components in dependence on the volume flow of conditioned air supplied from the supply line 39 of the aircraft air conditioning system via the connecting element 28. For example, the control unit 36 can move the ram air duct inlet flap 22 into its closed position and/or reduce a rotational speed of the conveying device 26 or switch off the conveying device 26 when the volume flow of conditioned air supplied to the ram air duct 16 via the connecting element 28 is sufficient to ensure a proper cooling of the heat exchanger 14.

Unlike in the aircraft cooling system 10 according to FIG. 1, in the arrangement illustrated in FIG. 2 conditioned air can be led into the ram air duct 16 also when the aircraft is in flight. As a result, the ambient air volume flow which has to be supplied to the ram air duct 16 when the aircraft is in flight in order to ensure a sufficient cooling of the heat exchanger 14 can be reduced. Consequently, the aerodynamic loss caused by the ram air duct 16 and thus the fuel consumption of the aircraft can be reduced.

Otherwise, the structure and the functioning of the aircraft cooling system 10 according to FIG. 2 correspond to the structure and the functioning of the arrangement illustrated in FIG. 1.

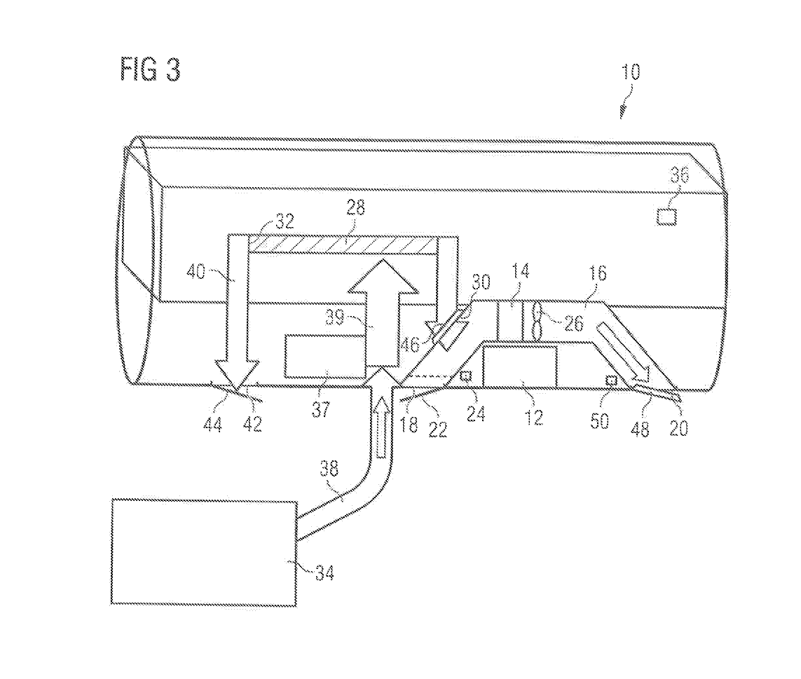

An aircraft cooling system 10 illustrated in FIG. 3 differs from the system according to FIG. 2 in that the connecting element 28 which serves to supply conditioned air to the ram air duct 16, at least in certain operating phases of the aircraft cooling system 10, is no longer connected at its second end to the supply line 39 of the aircraft air conditioning system which serves to supply conditioned air to the aircraft cabin. Rather, the second end 32 of the connecting element 28 is connected to the cabin exhaust air line 40, via which exhaust air is removed from the aircraft cabin into the aircraft surroundings. In the aircraft cooling system 10 according to FIG. 3, exhaust air, which would otherwise be removed to the aircraft surroundings unused, is thus used to cool the heat exchanger 14 arranged in the ram air duct 16. Normally, exhaust air removed from an aircraft cabin has a temperature of approx. 20 to 24° C. and is thus sufficiently cool to ensure a sufficient cooling of the heat exchanger 14. In the aircraft cooling system 10 according to FIG. 3, the device for providing conditioned air is consequently formed by the cabin exhaust air line 40.

Once again, a valve 46 configured in the form of a flap and arranged in the connecting element 28 serves to control the volume flow of conditioned air through the connecting element 28. Furthermore, a ram air duct outlet flap and/or an outlet nozzle 48 is provided. The operation of the ram air duct outlet flap 48 or the operation of an actuator 50 for actuating the ram air duct outlet flap 48 is controlled by the control unit 36, as is the operation of the ram air duct inlet flap 22 or the actuator 24 and the operation of the conveying device 26, in such a manner that sufficient air flows through the ram air duct 16 to ensure a proper cooling of the heat exchanger 14 arranged in the ram air duct 16. The air flowing through the ram air duct 16 can be exclusively cabin exhaust air branched off from the cabin exhaust air line 40. The ram air duct inlet flap 22, the ram air duct outlet flap 48 and the conveying device 26 can then be used to control the volume flow of conditioned air through the ram air duct 16 as desired.

Alternatively to this, however, additionally also ambient air can be led into the ram air duct 16, so that a mixed air flow containing conditioned cabin exhaust air from the cabin exhaust air line 40 and ambient air flows through the ram air duct 16. The ambient air supply into the ram air duct 16 is controlled, when an aircraft equipped with the aircraft cooling system 10 is in flight, by a corresponding control of the positions of the ram air duct inlet flap 22 and the ram air duct outlet flap 48. When the aircraft is on the ground, by contrast, the ambient air supply into the ram air duct 16 is controlled by corresponding control of the conveying device 26.

Otherwise, the structure and the functioning of the aircraft cooling system 10 according to FIG. 3 correspond to the structure and the functioning of the arrangement according to FIG. 2.

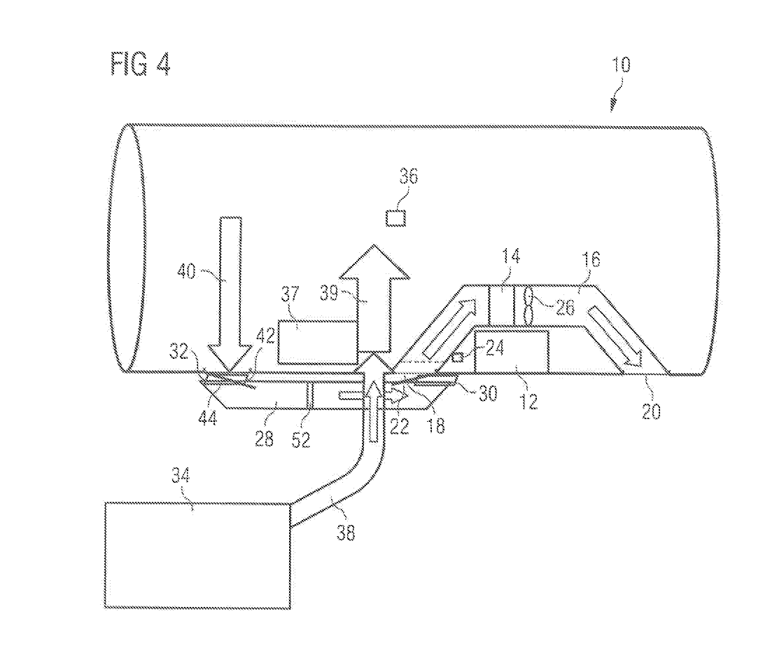

An aircraft cooling system 10 illustrated in FIG. 4 differs from the system according to FIG. 3 in that the connecting element 28 which connects the cabin exhaust air line 40 to the ram air duct 16 is no longer formed by an aircraft-internal air line. Rather, the connecting element 28 is configured in the form of an aircraft-external hose whose first end 30, similarly to the first end 30 of the connecting element 28 of the aircraft cooling system 10 shown in FIG. 1, is connected to the ram air inlet 18 of the ram air duct 16. The second end of the connecting element 28, by contrast, is connected to the cabin exhaust air outlet 42.

In order to control as desired the volume flow of conditioned air supplied to the ram air duct 16 via the connecting element 28, the control unit 36 in the cooling system 10 according to FIG. 4 controls the operation of the cabin exhaust air outlet valve 44 and the operation of the ram air duct inlet flap 22, i.e., the operation of the actuator 24 actuating the ram air duct inlet flap 22. Furthermore, if required, the conveying device 26 for conveying conditioned air into the ram air duct 16 can be used and correspondingly controlled by the control unit 36.

In the connecting element 28 there is provided a device 52 which serves to ensure a pneumatic uncoupling of the volume flow of conditioned air supplied to the connecting element 28 via the cabin exhaust air line 40 from the volume flow of conditioned air supplied to the ram air duct 16. As a result, differences between the volume flow of conditioned air supplied to the connecting element 28 and the volume flow of conditioned air led from the connecting element 28 into the ram air duct 16 can be compensated.

Otherwise, the structure and the functioning of the aircraft cooling system 10 according to FIG. 4 correspond to the structure and the functioning of the arrangement according to FIG. 3.

Features described here in connection with specific embodiments of an aircraft cooling system 10 can be combined with one another as desired.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An aircraft cooling system located in an aircraft and comprising:
a refrigerating device,
a heat exchanger thermally coupled to the refrigerating device,
a ram air duct adapted to supply cooling air to the heat exchanger, in order to remove waste heat generated in the operation of the refrigerating device from the heat exchanger to the aircraft surroundings, and
a connecting element comprising a first end connected to the ram air duct and a second end connectable to a device providing conditioned air and being adapted to supply conditioned air to the ram air duct, at least in certain operating phases of the aircraft cooling system.

2. The aircraft cooling system according to claim 1, wherein the first end of the connecting element is connected to one of a ram air duct inlet formed in an aircraft outer skin and to a region of the ram air duct located downstream of the ram air duct inlet.

3. The aircraft cooling system according to claim 1, wherein the second end of the connecting element is connectable to at least one of
an aircraft-external air conditioning unit,
an aircraft-internal air conditioning unit of an aircraft air conditioning system,
a supply line of the aircraft air conditioning system which is adapted to supply conditioned air to the aircraft cabin, and
a cabin exhaust air line for removing exhaust air from the aircraft cabin.

4. The aircraft cooling system according to claim 3, wherein the second end of the connecting element is connected to one of a cabin exhaust air outlet formed in an aircraft outer skin and a region of the cabin exhaust air line located upstream of the cabin exhaust air outlet.

5. The aircraft cooling system according to claim 1, further comprising a device for pneumatic uncoupling which is adapted to pneumatically uncouple a volume flow of conditioned air supplied to the connecting element from a volume flow of conditioned air coming out of the connecting element.

6. The aircraft cooling system according to claim 1, further comprising a control unit which is adapted to control the operation of at least one of
a valve of the connecting element,
a ram air duct inlet flap, and
a ram air duct outlet flap,
in such a manner that a volume flow of the conditioned air supplied to the ram air duct, at least in certain operating phases of the aircraft cooling system, corresponds to a desired volume flow.

7. The aircraft cooling system according to claim 6, wherein the control unit is adapted to determine the desired volume flow of the conditioned air supplied to the ram air duct, at least in certain operating phases of the aircraft cooling system, in dependence on at least one of an ambient temperature, a cooling output requirement demanded of the aircraft cooling system and a current capacity of the device for providing conditioned air.

8. A method for operating an aircraft cooling system comprising the steps:
generating cooling energy via a refrigerating device, and
supplying cooling air to a heat exchanger, thermally coupled to the refrigerating device, via a ram air duct, in order to remove waste heat generated in the operation of the refrigerating device from the heat exchanger to the aircraft surroundings,
wherein conditioned air provided by a device for providing conditioned air is supplied to the ram air duct, at least in certain operating phases of the aircraft cooling system.

9. The method for operating an aircraft cooling system according to claim 8, wherein conditioned air provided by the device for providing conditioned air is supplied to at least one of a ram air duct inlet formed in an aircraft outer skin and to a region of the ram air duct located downstream of the ram air duct inlet.

10. The method for operating an aircraft cooling system according to claim 8, wherein conditioned air is supplied to the ram air duct by at least one of
an aircraft-external air conditioning unit,
an aircraft-internal air conditioning unit of an aircraft air conditioning system,
a supply line of the aircraft air conditioning system which is adapted to supply conditioned air to the aircraft cabin, and
a cabin exhaust air line for removing exhaust air from the aircraft cabin.

11. The method for operating an aircraft cooling system according to claim 10, wherein conditioned air is supplied to the ram air duct from at least one of a cabin exhaust air outlet formed in an aircraft outer skin and a region of the cabin exhaust air line located upstream of the cabin exhaust air outlet.

12. The method for operating an aircraft cooling system according to claim 8, wherein a volume flow of conditioned air coming out of the device for providing conditioned air is pneumatically uncoupled from a volume flow of conditioned air supplied to the ram air duct.

13. The method for operating an aircraft cooling system according to claim 8, wherein the operation of at least one of
a valve of a connecting element which comprises a first end connected to the ram air duct and a second end connectable to the device for providing conditioned air,
a ram air duct inlet flap, and
a ram air duct outlet flap,
is controlled via a control unit in such a manner that a volume flow of the conditioned air supplied to the ram air duct, at least in certain operating phases of the aircraft cooling system, corresponds to a desired volume flow.

14. The method for operating an aircraft cooling system according to claim 13, wherein the control unit determines the desired volume flow of the conditioned air supplied to the ram air duct, at least in certain operating phases of the aircraft cooling system, in dependence on at least one of an ambient temperature, a cooling output requirement demanded of the aircraft cooling system and a current capacity of the device for providing conditioned air.
